(19) United States
(12) Patent Application Publication
(10) Pub. No.: US 2017/0323491 A1
(43) Pub. Date: Nov. 9, 2017

(54) METHOD AND DEVICE FOR TRACKING A PRODUCT PROCESSING LINE

(71) Applicant: GEBO CERMEX CANADA INC., Laval (CA)

(72) Inventors: Franck KLOTZ, Laval (CA); Simon BEAULNE, Laval (CA)

(21) Appl. No.: 15/522,964

(22) PCT Filed: Oct. 30, 2014
(86) PCT No.: PCT/IB2014/002273

§ 371 Date: Apr. 28, 2017

(51) Int. Cl. G07C 3/10; G07C 3/12

(52) U.S. Cl. CPC G07C 3/10; G07C 3/12

(57) ABSTRACT

A method for the real-time tracking of a processing line (1) comprising a series of product processing stations (2), and a plurality of accumulators (3) between said stations (2), said method comprising monitoring, in real time, the operation of the processing line (1), and reporting on said operation on a display means (5). The method is characterised by a step essentially consisting of calculating a duration for a processing station (2), said duration being calculated additively from the accumulation time (TA) represented by the instantaneous state of the accumulator (3) or of each accumulator (3) present between said station (2) and another predefined station (2) of the processing line (1), referred to as the reference station (4), and by a step essentially consisting of displaying said duration on a display means (5). The invention also concerns a suitable device. It is applicable, in particular, to multi-station bottle and flask packaging lines.

This invention pertains to the field of the industrial lines for processing products in a chain, in particular products to be packaged, and it has as its object, on the one hand, a method for tracking such a line, and, on the other hand, a device implementing this method.

A processing line can be summarized in a general way, within the scope of this invention, in a plurality of processing stations and a plurality of accumulators. The accumulators are placed between the processing stations and make it possible, of course, to prevent stoppages of a station impacting other stations.

Within a processing line, one of the stations is naturally the slowest, or the most difficult to stop or to restart, etc. In a general way, in any processing line, there is at least one station whose stoppage must absolutely be prevented or whose production rate is such that it could not be accelerated for compensating for overproduction upstream or gaps downstream. The processing line stations should therefore operate in such a way as to avoid stopping such a reference station due to a lack of product or saturation of the output, but also in such a way as to avoid having to accelerate the production rate. The maximum flow rate of the entire line depends on such a station.

Nevertheless, the operation of such a processing line is, naturally, confronted with stoppages, expected or not, in the area of one or the other of the stations. In these cases, it is important to know what the maximum conceivable duration of the stoppage is before disrupting the operation of this reference station, namely before arriving at a situation that should be compensated by an overrun and even a stoppage, which will directly impact the flow rate of the line.

To solve this problem, the invention proposes calculating and displaying, for each processing line station, in relation to a predefined reference station and taking into account, on the one hand, processing speeds and, on the other hand, the state of the accumulators, the maximum duration of a stoppage beyond which the operation of the reference station will be disrupted, and, consequently, the result of the line.

The invention thus has as its object a method for tracking in real time a processing line that comprises a series of stations for processing products, such as transformation stations or packaging stations, as well as a plurality of accumulators between said stations, with said method comprising monitoring in real time the operation of the processing line, in particular the quantities that are processed by the different stations, and even also their stoppages, as well as reporting on this operation on a display means, preferably in real time during the operation of the line.

This tracking method is characterized by a step that essentially consists in calculating a duration for a processing station, with said duration being calculated in an additive way starting from the accumulation time that represents the instantaneous state of the accumulator, or of each accumulator that is present between said station and another predefined station of the processing line, a so-called reference station, and by a step that essentially consists in displaying this duration.

The invention also has as its object a device for tracking a processing line that comprises a series of product processing stations as well as accumulators between said stations, with said device comprising a monitoring unit that comprises, on the one hand, a storing means and, on the other hand, a computer, with said monitoring unit being connected to different processing stations for receiving from them at least one piece of incremental information that represents the quantity of products that they have processed, with said device also comprising a display means of the screen type and for displaying, in a single location or near each processing station, a duration that represents its maximum authorized stopping time beyond which the operation of another station called a reference station will be disrupted due to a lack of product or due to saturation of its output.

The invention is intended in particular to be implemented in a line for packaging products, such as beverage bottles, liquid flasks, etc., where the unit products are processed, for example, for a cleaning, rinsing, filling, and then grouped in bundles, packed or bundled, and then deposited on palettes for the purpose of shipping. The processing stations can therefore be: filling, labeling, stoppering, grouping, bundling or packing, formation of layers to be palletized, and then palletization. This application is not limiting, however.

The invention will be better understood using the description below, which is based on possible embodiments, explained in a way that is illustrative and not at all limiting, with reference to the accompanying figures, in which:

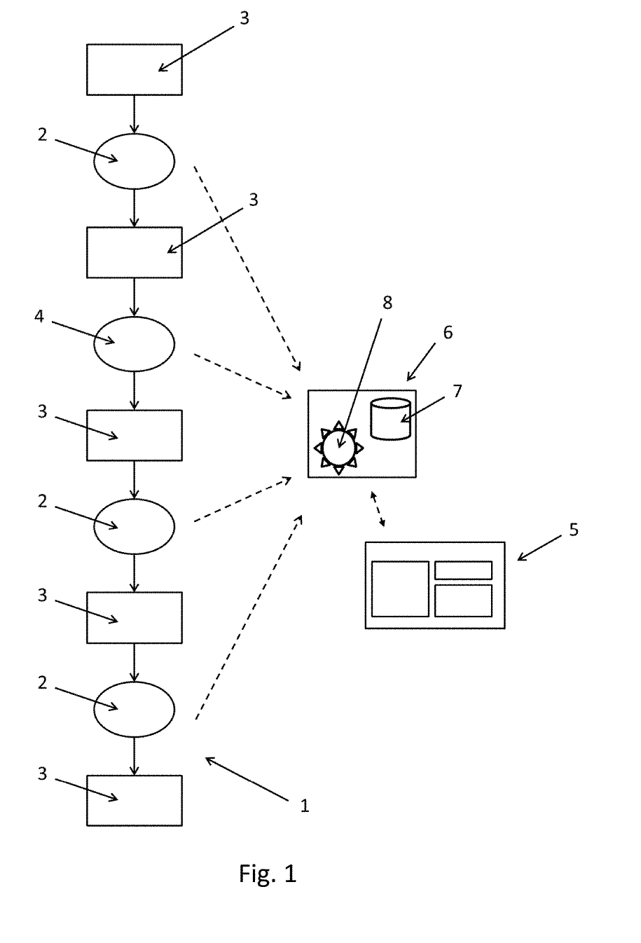

FIG. 1 illustrates diagrammatically the processing line and the tracking device where the reference station is the second station;

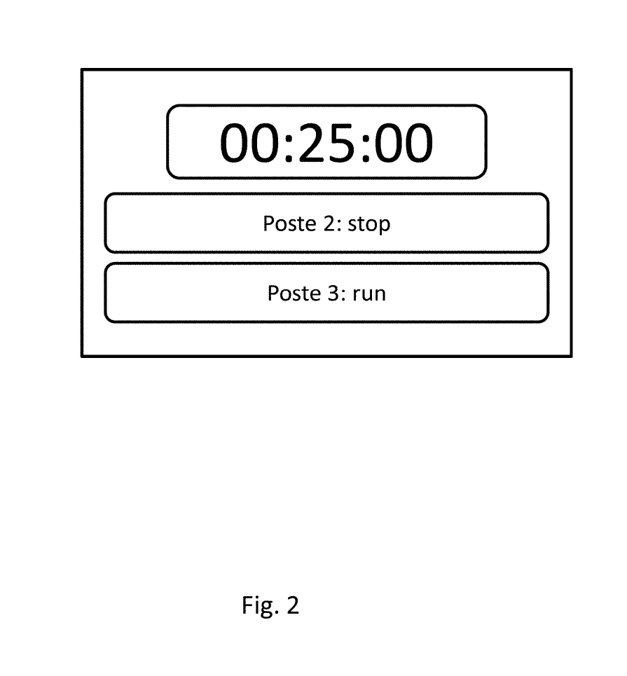

FIGS. 2 to 4 illustrate a generic representation of an interface for display and monitoring.

Thus, first of all, the invention has as its object a method for real-time tracking of a processing line 1 that comprises a series of stations 2 for processing products, such as transforming or packaging stations, as well as a plurality of accumulators 3 between said stations 2, with said method comprising

real-time monitoring of the operation of the processing line 1, in particular the quantities processed by the different stations 2, and even also their stoppages, as well as

reporting on this operation on a display means 5, preferably in real time during the operation of the line. The stations 2 are preferably equipped with sensors that can detect product gaps as well as sensors that can detect a saturation of the output. The stations 2 also preferably have a counter that can calculate in an incremental way the number of processed products from a forced value, in general zero. Taking the time into account between different readings of the counter then easily makes it possible to obtain a processing speed by the station 2 in question. Other signals or data can, of course, be processed during the monitoring.

The processing with different stations 2 can consist in a processing of product by product, or else group of products by group of products. The processing can be a labeling, an outer packaging, a grouping, a layering for palletizing, a conveying, etc. In a general way, in several of the targeted applications, the station 2 transforms the product and/or packages it. The products therefore circulate from one station 2 to the next to be processed completely once having left the line.

The stations 2, mounted in series and/or parallel, are separated by accumulators 3, preferably an accumulator 3 between two or more stations 2.

The products are therefore moved into the processing line 1 between the different stations 2 using suitable conveyors, which bring the products from one station 2 to the next. The accumulators 3 also have a fixed input zone and a fixed output zone. They therefore also ensure the conveying of the products from the input zone to the output zone. In addition to this conveying function, the accumulators 3 also make it possible to store products that then remain on standby between the input zone and the output zone. With the products having a certain space requirement, the number of products that can contain an accumulator 3 is directly linked to the dimensions thereof or to the maximum dimensions thereof in the case of an accumulator 3 with variable dimensions. The accumulation in terms of the product therefore also depends on the size of the product, i.e., its geometric format. The larger the product, the less the accumulator 3 can contain thereof; the smaller the product, the more it can contain thereof.

The method thus comprises a monitoring step, implemented at the same time as the processing line 1 is in production, and the stations 2 process products one after the other. This step makes it possible to monitor in real time the operation of the line and thus to verify its proper operation, in particular in terms of production rate or overall yield. The collected data can consist of production quantity readings of different stations 2, stopping time, cause of failure, need for maintenance, or supply of raw materials, etc. The data collected during the monitoring are in general processed then to report on the operation to an administrative user of the line under different possible forms.

According to the invention, this method is characterized by

a step that essentially consists in calculating a duration for a processing station 2, with said duration being calculated in an additive way starting from the accumulation time TA that represents the instantaneous state of the accumulator 3 or of each accumulator 3 that is present between said station 2 and another predefined station 2 of the processing line 1, a so-called reference station 4, and by

a step that essentially consists in displaying this duration preferably on the display means 5.

This calculation is preferably carried out within a monitoring unit 6. It therefore depends on the preliminary selection of a station 2 as a reference station 4, i.e., as a station 2 in relation to which the accumulation time TA is calculated. The reference station 4 can be predefined or parameterized by a user. It is in general the station that limits the maximum capacity of the processing line 1, taking into account its maximum production rate, for example.

If the station 2 of which said duration is calculated is separated from the reference station 4 by a single accumulator 3, the associated duration will be directly the accumulation time TA of this accumulator 3. In the opposite case, the accumulation times TA of the plurality of accumulators 3 between the station 2 of which the associated duration is calculated and the reference station 4 are simply added, taking into account, of course, the serial or parallel mounting of the stations 2 and accumulators 3.

The accumulation time TA for an accumulator 3 is directly associated with the number of products that it contains, and this time therefore changes based on the behavior, on the one hand, of the station 2 just upstream, and, on the other hand, of the station 2 just downstream. The accumulation time TA can therefore almost change continuously. In absolute terms, the accumulation time TA is therefore an instantaneous value that is associated with the state of the accumulator 3 at this moment. The duration to be associated with a processing station 2 can therefore also be varied at each moment, all the more so since it is calculated by an addition of accumulation times TA that themselves change at each moment. In practice, a refreshing frequency can be defined for the calculation of this duration.

Preferably, the accumulation time TA, at a given moment for an accumulator 3 that is located upstream from the reference station 4, is calculated starting from the number of products present at this moment in said accumulator 3, and the accumulation time TA, at a given moment for an accumulator 3 that is located downstream from the reference station 4, is calculated starting from the number of products that can still be accumulated in said accumulator 3 at this moment.

Actually, for a station 2 that is found upstream from the reference station 4, the disruption that it can create on the latter will appear when the reference station 4 will no longer have products to process. The accumulation time TA is therefore based on the number of products that are present in the accumulator 3 downstream, and that the reference station 4 can still process downstream without stopping, despite a possible stoppage of the station 2 upstream.

Conversely, for a station 2 downstream from the reference station 4, the disruption on the latter will appear when it can no longer release the product due to lack of space, i.e., in the case of saturation of its output. In this case, the accumulation time TA of an accumulator 3 that is placed between these two stations is based on the number of products lacking in the accumulator 3 at a given moment. This quantity represents the number of products that could still be added by the reference station 4 upstream in the event the station 2 stops downstream and therefore without taking products off said accumulator 3. This quantity therefore depends on the capacity of the accumulator 3.

According to a possible additional characteristic, the accumulation time TA at a given moment is calculated starting from the number of processed products, identified in an incremental way using counters, associated respectively with the station 2 upstream from the accumulator 3 and with the station 2 downstream from the accumulator 3, and that trace the cumulative quantity of products that they have processed, i.e., either entering into the accumulator 3 or exiting from said accumulator 3.

The stations 2 directly upstream or directly downstream from an accumulator 3 in general contain counters that count in an incremental way the number of products processed in these stations 2. The breakdown of the number of products processed by the upstream station represents the number of products that have been brought into the accumulator 3. The breakdown of the number of products processed by the downstream station represents the number of products that have been taken out of the accumulator 3. The accumulation time TA can therefore be calculated starting from these breakdown magnitudes. It will be explained later how these counter values can be used to evaluate not only the evolution of the quantity of products in the accumulator 3, but also the number of products effectively present at a certain moment: a trough in terms of the product population in the accumulator 3 can be associated with a zero population, a population peak can be associated with the maximum population taking into account the format and dimensions of the accumulator 3, etc.

More specifically, the accumulation time TA that represents the instantaneous state of an accumulator 3 is calculated, on the one hand, starting from the accumulation of products PA in the accumulator 3, and, on the other hand, starting from the speed of processing of the station 2 directly connected to the accumulator 3 in the direction of the reference station 4. The accumulation of products PA at a given moment for an accumulator 3 located upstream from the reference station 4 then corresponds to the number of products that are present at this moment in said accumulator 3. The accumulation of products PA at a given moment for an accumulator 3 located downstream from the reference station 4 corresponds to the number of products that can still be accumulated in said accumulator 3 at this moment. Finally, the number of products that can still be accumulated at a given moment in an accumulator 3 located downstream from the reference station 4 is calculated, on the one hand, starting from the capacity of said accumulator 3 in terms of the maximum number of products that it can contain, and, on the other hand, starting from the number of products that are effectively present in said accumulator 3 at this moment. It will be noted that the capacity of the accumulator 3, and therefore the number of products that it can still receive, depends on the geometric format of the product being processed.

According to an additional possible advantageous characteristic, the method comprises an initialization step, during which calibration parameters are defined for the calculation of the accumulation time TA, in particular the number of products present in the accumulator 3 at a particular moment and/or the maximum capacity of accumulation of the accumulator 3 for the geometric format of processed products, i.e., the largest number of products that it can contain.

This calibration is in particular necessary since a new format is processed by the line 1: in certain embodiments, the initialization step is implemented from the moment that the processing of a new geometric product format begins, impacting in particular the maximum number of products that the accumulator 3 can contain. This calibration can also be necessary if the tracking method is implemented while the processing line 1 is already operating and while all of the accumulators 3 already contain an indefinite number of products.

The calculation of the accumulation time TA therefore requires an initialization during which the capacity of the accumulator 3 is fixed in terms of the number of products that it can contain with the current format and/or the number of products present in the accumulator 3 is quantified at a certain moment in such a way as to be able then to exploit the counters quantifying the evolution of the population in the accumulator 3.

According to an advantageous characteristic, the initialization step essentially consists in consulting a register of a storing means 7 that associates possible types of products with corresponding calibration parameters, said register preferably being stored in a storing means 7 of the tracking device implementing this method. This makes it possible to quickly find the capacity of the accumulator 3 that is associated with the particular format of products.

However, it may happen that the product format for which it is sought to quantify the accumulation time TA is not associated with any information in the register. This can stem, for example, from the fact that this format has never yet been processed. In these cases, the initialization can be done in different ways that are described below.

In particular embodiments, the initialization step essentially consists in calculating the calibration parameters automatically starting from production readings for a period that has passed and for the same format, preferably starting from readings of counters associated respectively with the station upstream from the accumulator 3 and with the station downstream from the accumulator 3 and that trace the cumulative quantity of processed products, i.e., either entering into the accumulator 3 or exiting from said accumulator 3. By way of example, a population trough can be associated with a zero population, with the readings of the counters then being used to calculate the number of products in the accumulator 3 starting from this state. A population peak in the accumulator 3 can then be considered as being representative of a filled accumulator 3, and the number of calculated products for this peak can then be associated with the capacity of the accumulator 3 for this format.

Production data, which retrace the evolution of the counters of processed products as a function of time are actually in general available for the past. At the start-up of the tracking method, and in particular in the absence of values associated with the current format and stored in the register, it may be useful to analyze past and recorded values to exploit them in such a way as to calibrate the calculation of the accumulation time TA. These data can preferably represent units of products, and even of time, for example.

According to another possible characteristic, the initialization step essentially consists in calculating the calibration parameters automatically starting from production readings relative to a period of time that follows the start-up of the initialization step, preferably during a period of predetermined duration, in particular from readings of counters associated respectively with the station upstream from the accumulator 3 and with the station downstream from the accumulator 3 and that trace the cumulative quantity of processed products, i.e., either entering into the accumulator 3 or exiting from said accumulator 3. Thus, even though the tracking method is already in progress, retraces in real time the production of the processing line 1 and therefore displays a duration for each station 2 in relation to the reference station 4 that is optionally predefined by the operator, the parameters that are taken into account for the calculation of the accumulation times TA are defined and modified gradually for reflecting the current operation of the processing line 1. The displayed durations are therefore based on accumulation times TA that are calculated starting from parameters that are defined in an iterative way, in the course of readings carried out in real time on the processing line 1 that is in operation. This is particularly suitable in the cases where the tracking method is triggered whereas the processing line 1 is already in production operation, the data of the format is not accessible, or it is accessible but absent from the register that associates an accumulation duration therewith.

The tracking method is therefore calibrated gradually, after its start-up, based on the current production, and the calculations of the accumulation time TA are therefore increasingly precise, since they are based on values of capacity and/or instantaneous population of the accumulator 3 that are updated based on signals sent via the line, such as:
Readings of counters, able to lead to a negative value of the population and therefore an updating of the population;
Readings of counters, able to lead to a value of the population that is higher than the capacity and therefore an updating of the capacity;
Signals indicating a stoppage due to a lack of products both for the upstream station 2 and the downstream station 2, leading to identifying that the population is zero at this time;
Signals indicating a stoppage by saturation of the output both for the upstream station 2 and the downstream station 2, leading to identifying a “full” state of the accumulator 3 and therefore a possible updating of its capacity, etc.

It is therefore a matter of a self-training, which makes it possible to limit the manual intervention of an operator for correctly calibrating the calculation of the accumulation time TA starting from readings of the current production. This initialization step based on the current production can be calibrated over a predefined duration, or until the calibration parameters are considered to be stabilized.

According to another possible additional characteristic, the method also comprises an updating step, implemented after the initialization step and during the operation of the processing line 1, essentially consisting in modifying calibration parameters for the calculation of the accumulation time TA, in particular the number of products that are effectively present in the accumulator 3 at a particular moment and/or the maximum accumulation capacity of the accumulator 3 for the type of processed products and this in particular based on information that is representative of the state of operation of the processing line, such as readings from counters associated respectively with the station upstream from the accumulator 3 and with the station downstream from the accumulator 3 and that trace the cumulative quantity of processed products, i.e., either entering into the accumulator 3 or exiting from said accumulator 3.

The invention also has as its object a device for tracking a processing line 1 that comprises a series of stations 2 for processing products as well as accumulators 3 between said stations 2, with said device comprising a monitoring unit 6 that comprises, on the one hand, a storing means 7, and, on the other hand, a computer 8, with said monitoring unit 6 being connected to different processing stations 2 to receive from them at least one piece of incremental information representing the quantity of products that they have processed, with said device also comprising
a display means 5 of the screen type and for displaying, in a single location or close to each processing station 2, a duration that represents its authorized maximum stopping time beyond which the operation of another station 2 called a reference station 4 will be disrupted due to lack of products or due to saturation of its output.

This tracking device is therefore implemented by the tracking method described above. The display means 5 preferably comprises a screen, optionally also equipped with a tactile surface that makes it possible to grip and to send instructions, in particular, for example to select a format of products, to force or to prevent a calibration, stop an alarm, define the reference station 4, etc. The monitoring unit 6 communicates in a wired or wireless manner with the stations 2. Preferably, the communication between the monitoring unit 6 and the display means 5 is done in a wireless manner, in such a way as to use a piece of equipment that can be moved around the processing line 1.

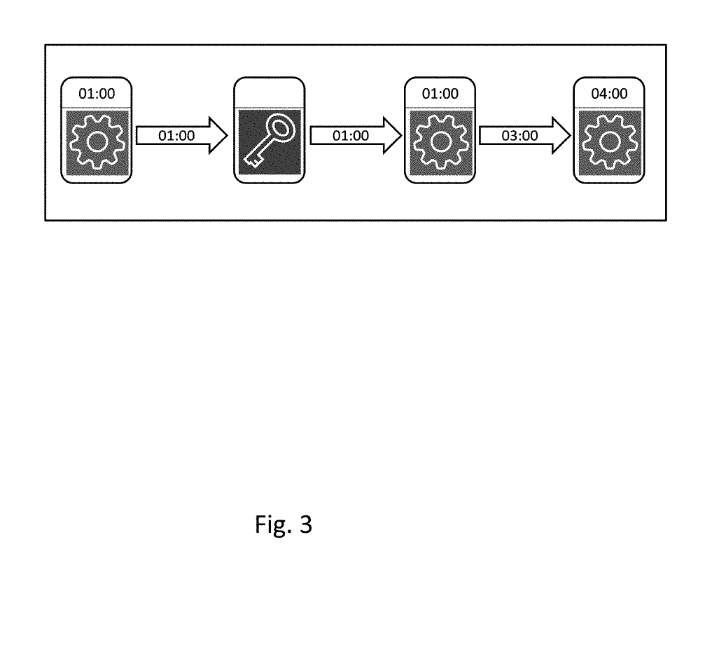

FIGS. 2 to 4 illustrate the display that is made starting from the duration associated with a station 2 in relation to a reference station 4. FIG. 2 illustrates a zone that can be installed in another display window that is associated with the station 2 to be analyzed. This zone contains the display of the calculated duration, and then optionally, below, the state of the upstream and downstream stations 2. By way of example, the zone that is illustrated in FIG. 2 stipulates a possible stoppage of 25 minutes for the station 2 in question. By selecting this zone, by the click of a mouse or by contact in the case of a tactile interface, the result advantageously is the interface that is shown in FIG. 3. This first zone of FIG. 1 that is specific to a station 2 and that can be located in different windows therefore provides access to all of the functions monitoring the possible duration of stoppage for the stations 2 of a processing line 1.

The zone that is shown in FIG. 3 sums up the instantaneous state of the accumulation for the processing line 1 in the form of a series of cards, each one associated with a station 2, and connections, each one associated with an accumulator 3. The card that is associated with the reference station 4 preferably takes on a different aspect from the others, such as, here, a key. The connections take up a number that represents the accumulation time TA for the accumulator 3. The duration associated with the station 2 is presented in the upper part of the card of station 2. In the part to the right of the reference station 4, it is seen, for example, that the first accumulator 3 downstream from the reference station 4 makes possible an accumulation time TA of 1 minute, presented in the station card 2 of the station directly downstream, since there is only one accumulator 3 between the reference station 4 and this station 2. The second accumulator 3 shows an accumulation time TA of 3 minutes. The addition of the accumulation time TA is presented in the upper part of the card for the rightmost station 2, or 4 minutes. The zone that is illustrated in FIG. 3 therefore shows in a synthetic way the entire line 1 and presents all of the durations for the different stations 2 as well as the accumulation times TA for all of the accumulators 3, with a graphic configuration that picks up the actual structure of the line 1, here stations that are mounted in series.

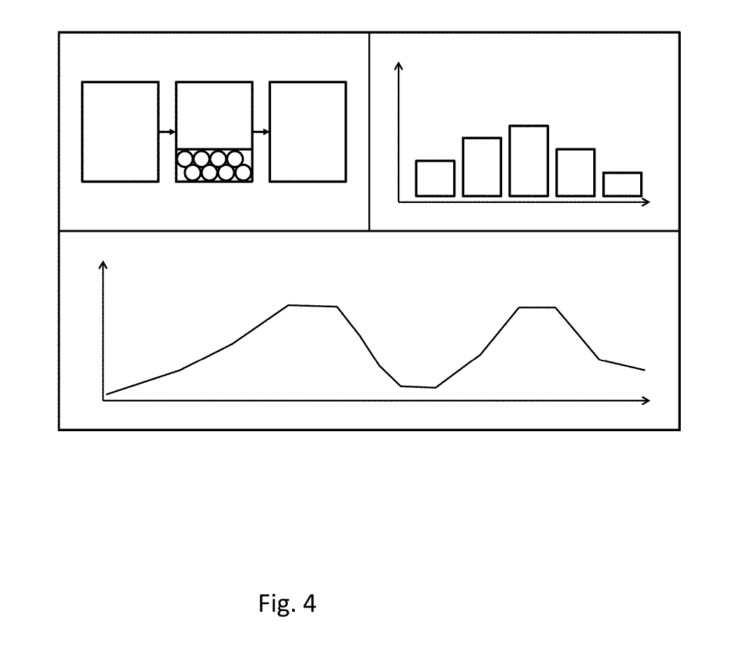

Finally, by selecting the time stipulated in the area of an accumulator 3 of FIG. 3, the zone of FIG. 4, specific to the selected accumulator 3, is displayed. The upper left part of this last zone shows three cards, the first for the station 2 upstream from the accumulator 3, the second for the accumulator 3 with a part that shows its proportion that is used by the products, and the third for the station 3 downstream from the accumulator 3. The other two zones describe the past operation of the accumulator 3:
The upper right part shows in diagram form a histogram that shows the distribution of the filling rates or accumulation times TA of the accumulator 3 over a range of time that has passed;
The lower part shows a diagram of the evolution over time of the population of products in the accumulator 3, or optionally the evolution over time of the accumulation time TA.

These display zones, illustrated in FIGS. 2 to 4, and the calculations of duration and accumulation time TA that are necessary can be implemented whereas the parameterization for these calculations, during the initialization step, is not finalized but is in progress.

The invention will now be explained with reference to the accompanying FIG. 1. In a general way, a processing station 2 can be one or more machines, with the flow between them being organized in series and/or in parallel. They are grouped in a single station 2 for the requirements of the method, to the extent that they are not separated by an accumulator 3 that it is desired to take into account. In the same way, the accumulator 3 can consist of multiple pieces of equipment that have this function and that are mounted in parallel and/or in series. It should be noted that the accumulator 3 shows in a general way the means for conveying products between two stations 2, even in the cases where their function is not specifically that of accumulating products.

As it has been emphasized, the processing line 1 in general comprises a reference station 4, whose stoppage is particularly detrimental for the production of the entire line. It may be a matter, for example, of the slowest machine, and it is therefore necessary to operate to its maximum capacity, which makes its operation in overdrive almost impossible to compensate for stoppages in production of other stations upstream or downstream.

Within this framework, the purpose of the invention is to provide and to display in real time a piece of information that is associated with each subsequent station 2 and that represents a duration below which a stoppage of said station 2 is not important to the operation of the reference station 4, which can therefore continue to be supplied and continue without stopping to provide processed products. For a station 2 upstream from the reference station 4, it is therefore necessary to quantify the duration of a stoppage starting from which the reference station 4 is no longer supplied with products. For a station 2 downstream from the reference station 4, it is necessary to quantify the duration of a stoppage starting from which the reference station 4 can no longer process products due to lack of space at the output. This information is then displayed in real time on a display means 5 that is associated with the station 2, for example on a screen that is dedicated to the station 2, or on a window of a central display.

The invention therefore proposes to quantify, in relation to a reference station 4, and in real time for each subsequent station 2 of the processing line 1, the maximum duration of a stoppage starting from which the operation of the reference station 4 will be disrupted. For this purpose, it is proposed to base the calculation of this maximum duration on the processing time that the state of the single accumulator 3 or each of the plurality of accumulators 3 found between the station 2 in question and the reference station 4 represents. As soon as the station 2 being considered and the reference station 4 are separated by at least two accumulators 3, the processing times associated with the states of these accumulators 3 are added, while taking into account, of course, mountings in series and/or in parallel between these two stations.

Thus, the maximum duration for a stoppage of a particular station 2 increases as one moves away from the reference station 4. This maximum duration of the stoppage of a station 2 depends, of course, on the instantaneous state of the accumulator or accumulators 3 between this station 2 and the reference station 4, i.e., as established later, on the number of products present or lacking. However, reporting on an accumulation in terms of the number of products is not enough to correctly plan possible stoppages for preventive maintenance, for example. It is therefore necessary to be able to associate easily an accumulation in terms of the number of products with an accumulation in the form of a time, i.e., an accumulation time TA.

The calculation of this accumulation time TA that makes a particular accumulator 3 possible depends on its position upstream or downstream from the reference station 4. The accumulation time TA at a certain moment, for a station 2 upstream from the reference station 4, corresponds to the production time that it makes possible at this moment in the downstream station 2 in the event of the stoppage of the upstream station 2. For a station 2 downstream from the reference station 4, the accumulation time TA at a certain moment corresponds to the production time that it makes possible at this moment in the upstream station 2 in the event of a stoppage of the downstream station 2. In a general way, the accumulation time TA therefore corresponds, in an instantaneous way, to the production time that the accumulator 3 makes possible in the station 2 just after it by going toward the reference station 4, in the event of a stoppage of the station 2 just after it by moving away from the reference station 4.

In the case of an accumulator 3 that is located upstream from the reference station 4, the accumulation time TA at a given moment is defined on the basis of the number of products that are present in the accumulator at this moment. The processing speed to be taken into account for associating this quantity of products with an accumulation time TA is that of the station just downstream, which can in particular be the reference station 4.

In the case of an accumulator 3 that is located downstream from the reference station 4, the accumulation time TA at a given moment is defined based on the number of products that, at this moment, could also be received, taking into account the size of the accumulator 3 and the capacity for receiving products that this represents, taking into account the size or format of the product. The processing speed to be taken into account for associating this quantity of products with an accumulation time TA is then that of the station just upstream, which can also be, for example, the reference station 4.

In addition, in the case of such an accumulator 3, placed downstream, this quantity of products that are lacking at a given moment is calculated by taking into account, on the one hand, the total capacity of the accumulator 3 for the current format, and, on the other hand, the quantity of products that it contains at this moment. The total capacity of the accumulator 3 is, of course, a value that does not fluctuate for the same geometric format of products. However, as will also be described later, establishing the value of the capacity of the accumulator 3 can be done by the tracking method itself.

Preferably, in a general way, the speed of a station 2 taken into account for defining an accumulation time TA starting from a number of products is a speed calculated starting from a counter that follows the evolution over time of the number of products processed by the station 2. The speed taken into account is preferably the most recent.

Whether for an accumulator 3 located upstream from the reference station 4 or for an accumulator 3 located downstream, it is therefore always necessary to know the quantity of products that it contains. To do this, it is proposed here to take as a basis the processing breakdowns, on the one hand, of the processing station 2 directly upstream from the accumulator 3 being considered, as well as, on the other hand, the processing station 2 directly downstream from this accumulator 3.

Actually, a processing station 2 is in general equipped with a counter, which quite simply calculates in an incremental way the number of products processed by said station 2. By taking into account these counter values, for the upstream station 2 and the downstream station 2 and this at two separate moments, it is possible to quantify the variation of the number of products contained in the accumulator 3: the difference of counters for the station 2 upstream from the accumulator 3 represents the number of products provided to the accumulator 3 between these two moments, whereas the difference of counters for the downstream station 2 represents the number of products that have exited from the accumulator 3.

The quantity of products contained in an accumulator 3, necessary to the calculation of the accumulation time TA for an accumulator 3, can therefore be calculated, on the one hand, starting from readings of counters of the stations 2 directly upstream and downstream, and, on the other hand, starting from a moment in the operation of the processing line 1 with which is associated a certain quantity of products contained in the accumulator 3, for example zero at the beginning of production, etc.

By using the data of the counter of the stations 2, the use of specific sensors as a basis in the area of the accumulator 3, which is not systematically available and complicates the implementation of the method in a processing line 1 that does not have such sensors, is avoided.

The calibration can be manual, with a user then assigning to himself, for an accumulator 3, the number of products that are present at the desired moment, and even also the total capacity of the accumulator 3 for a particular format, optionally in a register that is consulted below for a calibration. However, it may be particularly advantageous to propose a method in which the user does not need to intervene, which also makes it possible to take into account the reality of the production rather than theoretical data. In addition, it is not always possible to stop a processing line 1 for emptying all of the accumulators 3 and distributing with certainty from a state where the quantity of products present is zero. Finally, in the case of a new format, the exact capacity of the accumulators 3 is sometimes not known.

Thus, it is also proposed that the tracking method have an initialization step, during which a particular moment in the production is associated with a particular quantity of products in the accumulator 3, and a value is defined for the capacity of the accumulator 3 with the format of the current product. As will be described later, this initialization or calibration can be done by being based on the readings of past operation of the processing line 1 and for the same format, in particular the readings of operation in terms of the counter of products processed by a station 2, or else situations of lacking products upstream from the station 2 or of saturation of the output of the station 2. These past operation readings can therefore be used to evaluate the number of products present as well as the capacity of the accumulator 3.

As has already been specified, the definition of the accumulation time TA is done starting from a processing speed of the station 2 in question and an accumulation in terms of the number of products, representing either the number of products present in the accumulator 3 or the number of products that can still be added.

The definition of the accumulation time TA therefore requires defining parameters such as, on the one hand, the capacity of the accumulator 3 in terms of products taking into account the format, and, on the other hand, at least the number of products that it contains at a certain moment. The capacity of the accumulator 3 in terms of the number of products depends in particular on the size of the products and therefore their geometric format. As soon as the geometric format of the products changes, it becomes necessary to define this calculation parameter again.

Thus, during the initialization step, the parameters that are necessary for the calculation of the accumulation time TA of each accumulator 3 are defined, namely at least the maximum capacity of the accumulator 3 that is associated with the geometric format of the product and optionally also a state of reference of the accumulator 3 where the number of products is defined.

This initialization step can be implemented upon the start-up of the tracking method, in particular if the processing line 1 is in operation and should therefore avoid being stopped. It can also be implemented upon the occasion of a change in product format, which, as has been emphasized above, in general requires an adjustment at least of the capacity of the accumulator 3. Finally, in a general way, it can be implemented upon the occasion of the start-up and the actuating of the processing line 1.

Advantageously, the initialization is done by minimizing the intervention of an operator. In particular, for the purpose of self-calibration without intervention, it is proposed that the parameters mentioned above be calculated by observing the production of the processing line 1, either over a range of past production time or over a range of current production time.

In particular, it is possible to analyze past production data, stored in a particular register. These data can be, for example, the readings of counters of the stations 2 directly upstream and directly downstream from the accumulator 3.

For example, for an accumulator 3 that is placed between a station 2 at the input, which feeds it, and a station 2, at the output, fed by the accumulator 3, the readings from counters of each of the two stations are used over a range of past processing times that is long enough, for example a day or a week. As has already been explained, these readings make it possible to follow the evolution of the quantity of products present in the accumulator 3 during the period that is observed.

The initialization then essentially consists in, for example, detecting the moment that corresponds to the least filled state of the accumulator 3 over the observed period and associating with this moment a zero product quantity. It also consists in calculating the total capacity of the accumulator 3 using breakdowns of the stations 2 at the input and at the output of the accumulator up until a moment that corresponds to the most filled state of the accumulator 3 over the observed period.

The initialization can also essentially consist in detecting a moment during which the station 2 upstream from the accumulator 3 as well as the station 2 downstream are both in a situation of lacking products and in associating with this moment a zero value for the quantity of products contained in the accumulator 3.

The initialization can in this case, for example, consist in detecting the moment that corresponds to the most filled state of the accumulator 3 over the observed past period and in associating with this moment a quantity of products corresponding to the maximum capacity predefined by construction.

The initialization step can also consist in detecting a moment during which the station 2 upstream from the accumulator 3 as well as the station 2 downstream are both in a situation of saturation of their output, which can be considered to be a situation where the accumulator 3 is completely full. There again, the quantity of products 3 corresponding to the maximum capacity is associated with this moment.

By using the past readings of operation of the processing line 1, it is possible to define the parameters to be taken into account for calculating the accumulation time TA in a way that does not require the intervention of an operator and that, in addition, represents the actual characteristics of the processing line 1. Preferably, during the calibration step, data relative to a processing of products of the same size or format are examined.

Another way of implementing the self-calibration of the calculation of the accumulation time TA is to track the operation of the processing line 1 that takes place, which can be done while the method is in progress and therefore displays results of the duration. This therefore makes it possible to calibrate the calculation in the production that is in progress.

The same mechanisms as those that have been described above for a past duration can therefore be implemented for data collected starting from the implementation of the method, for a previously predefined period of time. In particular, the capacity of the accumulator 3 can, during this initialization step during production, be regularly updated as soon as the counters lead to a number of products higher than the previously stored capacity. During the observation period over which the initialization step is spread, it is also possible to detect the peak of the population in the accumulator 3 and to use it as a value of the capacity for the accumulator 3.

In the two cases that were just presented in detail, the analysis of the data of a production period, past or current, thus makes it possible to define at least the capacity of receiving the accumulator 3 associated with the format of current products during said period. It is therefore useful to ensure a storing of this data in a safeguarding register that can then contain a plurality of data representing, on the one hand, the geometric formats of products, and, on the other hand, the corresponding total capacities of the accumulators 3.

It should be noted that relative to the definition of the capacity of the accumulator 3, the initialization step can essentially consist in consulting such a register and in then identifying instantaneously the maximum capacity of the accumulator 3 associated with the current format. The initialization step then essentially consists in consulting the register for the current product format: if no data are available for the current format, the analyses described above for ranges of production are then executed, first by using data relative to a past production and for the same format, or by using data relative to a current production.

Once the parameters that are necessary to the calculation of the accumulation time TA have been defined by one of the ways described above for the initialization step, it is possible to display, on a screen for monitoring each station 2, the more specific duration associated with said station 2, by taking into account in an additive way the accumulation times TA of each accumulator 3 between this station 2 and the reference station 4. The calculation takes into account, of course, the mounting in series and/or in parallel of the stations 2 and the accumulators 3. Of course, the display of the duration associated with a station 2 can be done even before the end of the initialization step, although this duration is then less precise because it is based on parameters that are not necessarily stabilized.

After the initialization step, the parameters for calculation of the accumulation time TA can be updated based on production tracking information, which makes it possible to take into account, if necessary, modifications that have been provided to the equipment of the processing line 1, such as a motor, for example.

The capacity of the accumulator 3 can, for example, be updated as soon as the counters of the upstream and downstream stations 2 lead to a number of products that it contains that is higher than the stored capacity, etc.

Preferably, it may be advantageous to ensure a tracking of the number of products in an accumulator 3 over a sliding range of time that has passed, and to identify, in this time range, at least one population peak and/or at least one population trough.

If the value of the at least one peak is not found in a section in relation to the capacity associated with the current format, a particular behavior can be put into place, such as, for example, an alarm, or else a proposal for updating the capacity.

A similar operation can be provided if the value of the at least one population trough is not found in a predefined section. In particular, if the calculated value of the population becomes negative, the former is optionally forced to a zero value. If it is always well above zero, it can be proposed to readjust these moments to a zero value population.

Finally, the operation of a processing line 1 can be modified by a change in format of the products to be packaged, for example. In addition, products may be defective and can be withdrawn from the line in the area of an accumulator 3, etc. For these reasons in particular, the initialization step can be implemented multiple times during the operation of the processing line 1.

The signals of the sensors that represent the filling of the accumulator 3 can also be taken into account either instead of the production counters on the stations 2 for an initialization step or for updating the parameters of the calculation once the initialization step has ended.

Thanks to the invention, it is thus possible to follow continuously the state of the processing line and to know precisely, and while limiting the manual parameterization steps for each station of the processing line, the possible durations of stoppage without impact on the overall flow of the line.

Although the description above is based on particular embodiments, it is in no way limiting of the scope of the invention, and modifications can be provided, in particular by substitution of equivalent techniques or by a different combination of all or part of the characteristics developed above.

1. Method for real-time tracking of a processing line (1) comprising a series of stations (2) for processing products, such as transformation stations or packaging stations, as well as a plurality of accumulators (3) between said stations (2), with said method comprising
monitoring in real time the operation of the processing line (1), in particular the quantities that are processed by the different stations (2), and even also their stoppages, as well as
reporting on this operation on a display means (5),
the method comprising:
a step that essentially consists in calculating a duration for a processing station (2), with said duration being calculated in an additive way starting from the accumulation time (TA) that represents the instantaneous state of the accumulator (3) or of each accumulator (3) that is present between said station (2) and another predefined station (2) of the processing line (1), a so-called reference station (4), and
a step that essentially consists in displaying this duration.

2. Method according to claim 1, where
the accumulation time (TA), at a given moment for an accumulator (3) located upstream from the reference station (4), is calculated starting from the number of products present at this moment in said accumulator (3).

3. Method according to claim 1, where
the accumulation time (TA), at a given moment for an accumulator (3) located downstream from the reference station (4), is calculated starting from the number of products that can still be accumulated in said accumulator (3) at this moment.

4. Method according to claim 1, where
the accumulation time (TA) at a given moment is calculated starting from the number of products processed, identified in an incremental way using counters, associated respectively with the station (2) upstream from the accumulator (3) and with the station (2) downstream from the accumulator (3), and which trace the cumulative quantity of products that they have processed, i.e., either entering into the accumulator (3) or exiting from said accumulator (3).

5. Method according to claim 4, further comprising an initialization step, during which the calibration parameters for the calculation of the accumulation time (TA) are defined.

6. Method according to claim 5, where
the initialization step is implemented as soon as the processing of a new geometric format of the product begins, impacting in particular the maximum number of products that the accumulator (3) can contain.

7. Method according to claim 5, where
the initialization step essentially consists in consulting a register of a storage means (7) that associates possible product types with corresponding calibration parameters.

8. Method according to claim 5, where
the initialization step essentially consists in calculating the calibration parameters automatically starting from production readings for a past period and for the same format.

9. Method according to claim 5, where
the initialization step essentially consists in calculating the calibration parameters automatically starting from production readings relative to a time period that follows the start-up of the initialization step.

10. Method according to claim 5, characterized by
an updating step, implemented after the initialization step and during the operation of the processing line (1), essentially consisting in modifying calibration parameters for the calculation of the accumulation time (TA).

11. Device for tracking a processing line (1) that comprises a series of product processing stations (2) as well as accumulators (3) between said stations (2), with said device comprising
a monitoring unit (6) that comprises both a storage means (7), as well as a computer (8), with said monitoring unit (6) being connected to different processing stations (2) for receiving from them at least one piece of incremental information that represents the quantity of products that they have processed, with said device also comprising
a display means (5) of the screen type and for displaying, in a single location or close to each processing station (2), a duration that represents its authorized maximum stopping time beyond which the operation of another station (2), a so-called reference station (4), will be disrupted due to lack of product or due to saturation of its output.

12. Device according to claim 11, where
the communication between the monitoring unit (6) and the display means (5) is done in a wireless manner.

13. The method of claim 1, wherein the reporting on the operation on the display means (5) is performed in real time during the operation of the line and after processing data collected during the monitoring.

14. Method according to claim 2, where
the accumulation time (TA), at a given moment for an accumulator (3) located downstream from the reference station (4), is calculated starting from the number of products that can still be accumulated in said accumulator (3) at this moment.

15. Method according to claim 2, where
the accumulation time (TA) at a given moment is calculated starting from the number of products processed, identified in an incremental way using counters, associated respectively with the station (2) upstream from the accumulator (3) and with the station (2) downstream from the accumulator (3), and which trace the cumulative quantity of products that they have processed, i.e., either entering into the accumulator (3) or exiting from said accumulator (3).

16. Method according to claim 3, where
the accumulation time (TA) at a given moment is calculated starting from the number of products processed, identified in an incremental way using counters, associated respectively with the station (2) upstream from the accumulator (3) and with the station (2) downstream from the accumulator (3), and which trace the cumulative quantity of products that they have processed, i.e., either entering into the accumulator (3) or exiting from said accumulator (3).

17. Method according to claim 6, where
the initialization step essentially consists in consulting a register of a storage means (7) that associates possible product types with corresponding calibration parameters.

18. Method according to claim 6, where
the initialization step essentially consists in calculating the calibration parameters automatically starting from production readings for a past period and for the same format.

19. Method according to claim 6, where
the initialization step essentially consists in calculating the calibration parameters automatically starting from production readings relative to a time period that follows the start-up of the initialization step.

20. Method according to claim 6, further comprising an updating step, implemented after the initialization step
and during the operation of the processing line (1), essentially consisting in modifying calibration parameters for
the calculation of the accumulation time (TA).
